(19) United States
(12) Patent Application Publication
(10) Pub. No.: US 2011/0221217 A1
(43) Pub. Date: Sep. 15, 2011

(54) Finger-manipulated grasping device

(76) Inventors: John Patrick Grosse, Plymouth, MN (US); Benjamin David Prescott, Minneapolis, MN (US)

(21) Appl. No.: 12/661,331

(22) Filed: Mar. 15, 2010

(51) Int. Cl. B25B 9/02

(52) U.S. Cl. 294/99.2

(57) ABSTRACT

A device for assisting manual grasping of articles, the device having:
a) a common base;
b) at least three arm elements articulating from the common base;
c) each arm having a flexing zone with the common base; and
d) each arm having a surface against which applied digital pressure will cause each of the three to flex towards a central grasping zone.

### BACKGROUND OF THE INVENTION

1. Field of the Invention

The present technology relates to hand-operated tools, particularly finger-manipulated tools, and most particularly grasping devices that can be digitally operated.

2. Background of the Art

It is often desirable or necessary for relatively small objects without contacting them with bare hands. Sometimes it is hygienically desirable to not actually contact an article, sometimes it would be dangerous to directly touch an article (because of heat, acidity, or chemical activity) and sometimes it is socially unacceptable to directly touch communal foods. Different tools have been devised for various special purposes.

Elastomeric (e.g., silicon) mittens and gloves are used as thermal protectors in kitchens and laboratories. Ice tongs are used to grasp blocks or cubes of ice. Pliers, wrenches and many other common tools are available for special needs. Most known tools attempt to provide parallel opposed planes as the basis for grasping and securing an object. Opposed planes are not necessarily the best way of securing and stabilizing objects that themselves do not possess opposed planar surfaces.

It is always desirable to provide additional tools for general purposes that can be easily manufactured and the use of which can be easily learned.

### SUMMARY OF THE INVENTION

A device assists in the manual grasping of articles. The device has at least:

a) a common base;

b) at least three arm elements articulating from the common base;

c) each arm having a flexing zone with the common base; and

each arm having a surface against which applied digital pressure.

### BRIEF DESCRIPTION OF THE FIGURES

FIG. 1 shows a heat-resistant, molded elastomeric device according to disclosed technology.

FIG. 2 shows the fingers of a hand inserted into opposing flexible finger sleeves of the elastomeric device of FIG. 1.

FIG. 3 shows an alternative structure within the present technology of a three-armed or three-prong grasping device.

FIG. 4 shows yet another an alternative structure within the present technology of a three-armed or three-prong grasping device.

FIG. 5 shows a person's hand using the grasping device of FIG. 4.

FIG. 6A shows a molded grasping element in a planar form that has not been pressed into a grasping shape by digital force.

FIG. 6B shows the element of 6A that has been slightly forced into a grasping shape.

FIG. 6C shows a nearly closed element of FIG. 6A.

FIG. 7 shows five different frictional or grasping distal ends of an arm for the element of FIG. 6A.

### DETAILED DESCRIPTION OF THE INVENTION

A device assists in the manual grasping of articles. The device has at least:

d) a common base;

e) at least three arm elements articulating from the common base;

f) each arm having a flexing zone with the common base; and

g) each arm having a surface against which applied digital pressure will cause each of the three to flex towards a central grasping zone.

The common base may have a defined or irregular geometric shape. The geometric shape may have equilateral or dissimilar sides. For purposes of discussion and not limiting the scope of the disclosure, equilateral sides will be discussed to simplify the discussion. Similarly, a three-arm device will be discussed, although a four arm element may also be used within the practice of the present technology.

The common base and at least three arm elements may comprise or consist of a single piece of molded polymeric material or may be made of multiple fused, adhered or snap engaged segments. The flexing zone may be a living hinge or may have an elastomeric element bridging the common base and the arms to form a flexing zone, or actual hinges with central pin and rotating cover or with engaging slots in cylinders may be used as known common hinge technology.

The common base, flexing zone and a least three arms may comprise an elastomeric composition. The common base and a portion of the at least three arm elements adjacent the common base consist of a single piece of molded polymeric material and there is at least one extension attached to the portion of at least one arm that comprises a second material different from the molded polymeric material. The second material comprises a metal, rigid polymer, wood or composite material at a distal end of the at least one arm.

The common base may have a triangular or quadrilateral shape and there are exactly three or four arms, respectively. In one embodiment, each arm is wider at the flexing zone than at its end most distal from the flexing zone to provide a tapered appearance. A surface of at least one arm facing the central grasping zone may have a friction increasing surface at a distal end of the arm away from the flexing zone or all arms may have a friction increasing inner surface (inner towards the grasping zone). Similarly, a surface of at least one arm facing the central grasping zone may have a piercing element at a distal end of the arm away from the flexing zone. The surface against which is applied digital pressure may have a friction increasing surface (e.g., grooves, abrasive, texture, etc.) that reduces digit slipping as digital pressure is applied. In one embodiment, each arm comprises a digital sleeve having a fingertip cover at a distal end of the arm away from the flexing zone. In this last embodiment, a surface of at least one arm facing the central grasping zone has a friction increasing surface at a distal end of the arm away from the flexing zone. In this last embodiment, the common base and at least three arm elements consist of a single piece of molded polymeric material and/or the polymeric material comprises an elastomeric polymer. Elastomeric materials include, but are not limited to natural rubber, synthetic rubber, silicon resins, polyurethanes, fluoropolymers, ethylenically unsaturated polymers (e.g., styrene/butadiene/acrylonitrile and acrylic elastomers) and the like.

The more rigid (yet having tolerable brittleness) polymers used in materials having less elastomeric properties include, but are not limited to ethylenically unsaturated resins (e.g., polystyrene, polyolefins such as polyethylene and polypropylene, and polyvinyl resins), polyamides, polyacrylic resins, and the like.

Reference to the Figures will assist in a further appreciation of the scope of technology disclosed herein.

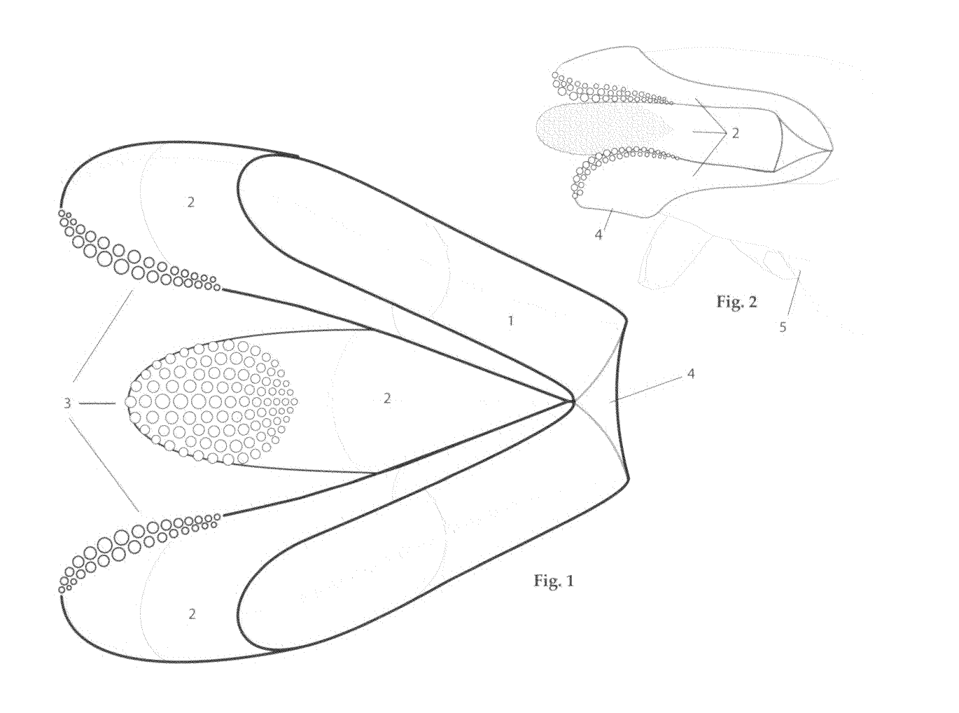

FIG. 1 shows a heat-resistant, molded elastomeric device 4 according to disclosed technology. The device 4 has a base composition 1 of molded elastomeric resin such as silicon elastomer. There are three opposed flexible finger sleeves 2 with molded bumps or gripping protuberances 3 on the finger sleeves 2.

FIG. 2 shows the fingers of a hand 5 inserted into opposing flexible finger sleeves 2 of the elastomeric device 4 of FIG. 1.

FIG. 3 shows an alternative structure within the present technology of a three-armed or three-prong grasping device 10. The alternative device 10 will have the common base 18 (which may be a distinct element or a continuous molded component of the device 10), a flexing zone 17 adjacent the common base 10, the three opposed arms or extensions thereof 16 and the grasping distal ends 15 with grasping or piercingelements 8 at the more distal tip of the distal ends 15. Elements 15, 16, 17 and 18 may be the same or different compositions, but in the particular structure shown, common base 18, flexing zone 17 should be of the same material, and the first extension area 16 may be a different polymeric or metal or composite material, and the distal end 15 may be another or similar range of materials, including the elastomers, more rigid polymers, metals, composites, wood, ceramic, glass and the like.

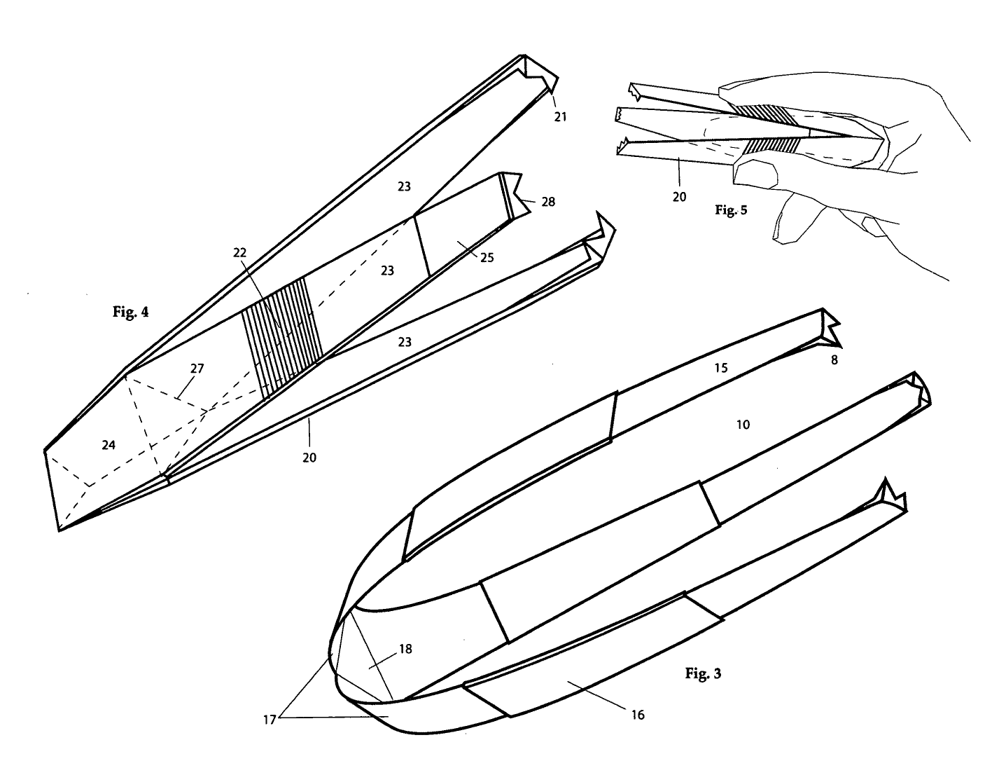

FIG. 4 shows yet another alternative structure 20 within the present technology of a three-armed or three-prong grasping device. The device of FIG. 4 has a common base 24 which shown as a three-dimensional section rather than the planar base of previous figures and may be solid or hollow. There are three arms 23 and the flex zones 27. There is the surface friction area 22 of grooves to prevent finger slippage and a distal section 25 with the pointed prongs 21 at the end of the distal section 25. It is to be noted that the three arms 23 do not oppose each other in opposed planat fashion, but are able to move to a common central area to grasp an object with three point control.

FIG. 5 shows a person's hand using the grasping device 20 of FIG. 4.

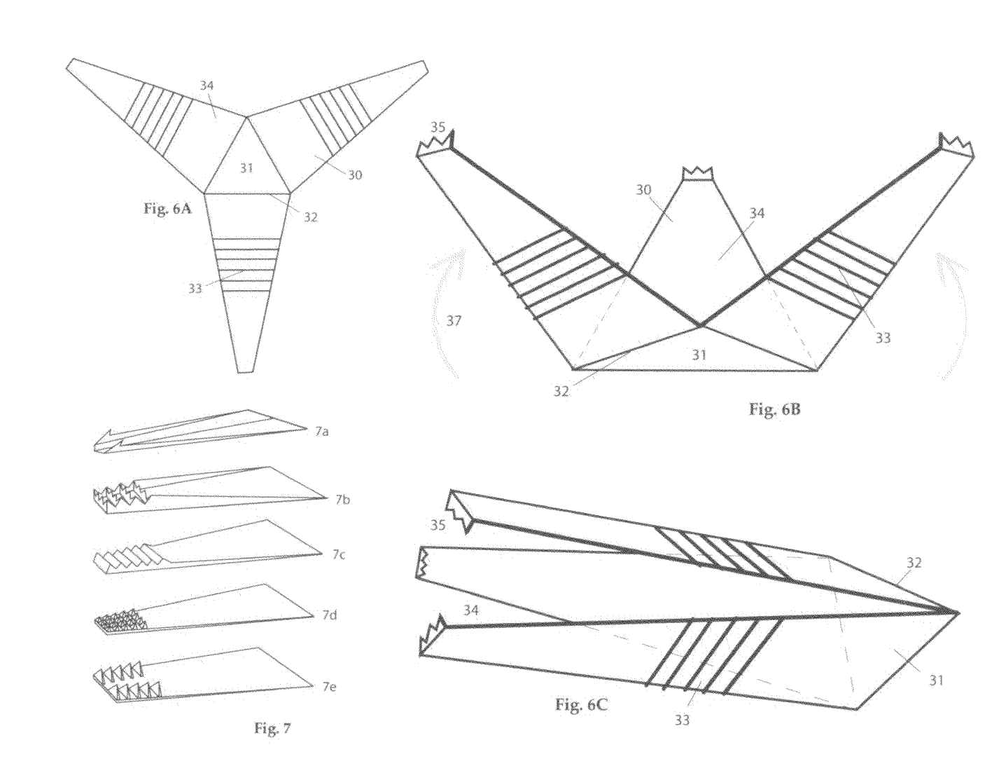

FIG. 6A shows a molded grasping element 30 in a planar form that has not been pressed into a grasping shape by digital force. The common base 31, three arms 34 and friction gripping area 33 are shown.

FIG. 6B shows the element 30 of 6A that has been slightly forced into a grasping shape by rotation of arms 34 along curved path 37.

FIG. 6C shows a nearly closed element 30 of FIG. 6A with the prongs 35 advanced towards a central grasping area.

FIG. 7 shows five different frictional or grasping distal ends 35 of an arm for the element 30 of FIG. 6A. Elements 7a, 7b, 7c, 7d and 7e are variations of structures that can be used in the practice of the grasping device technology.

Although specific materials, sizes and structures have been described, variations within the scope of the generic disclosure may be practiced within the scope of the claims presented here.

What is claimed:

1. A device for assisting manual grasping of articles, the device comprising:
h) a common base;
i) at least three arm elements articulating from the common base;
j) each arm having a flexing zone with the common base; and
k) each arm having a surface against which applied digital pressure will cause each of the three to flex towards a central grasping zone.

2. The device of claim 1 wherein the common base and at least three arm elements consist of a single piece of molded polymeric material.

3. The device of claim 2 wherein the flexing zone is a living hinge.

4. The device of claim 2 wherein the common base, flexing zone and a least three arms comprise an elastomeric composition.

5. The device of claim 1 wherein the common base and a portion of the at least three arm elements adjacent the common base consist of a single piece of molded polymeric material and there is at least one extension attached to the portion of at least one arm that comprises a second material different from the molded polymeric material.

6. The device of claim 5 wherein the second material comprises a metal or composite material at a distal end of the at least one arm.

7. The device of claim 1 wherein the common base is triangular and there are exactly three arms.

8. The device of claim 7 wherein each arm is wider at the flexing zone than at its end most distal from the flexing zone.

9. The device of claim 1 wherein a surface of at least one arm facing the central grasping zone has a friction increasing surface at a distal end of the arm away from the flexing zone.

10. The device of claim 1 wherein a surface of at least one arm facing the central grasping zone has a piercing element at a distal end of the arm away from the flexing zone.

11. The device of claim 1 wherein the surface against which is applied digital pressure has a friction increasing surface that reduces digit slipping as digital pressure is applied.

12. The device of claim 1 wherein each arm comprises a digital sleeve having a fingertip cover at a distal end of the arm away from the flexing zone.

13. The device of claim 12 wherein a surface of at least one arm facing the central grasping zone has a friction increasing surface at a distal end of the arm away from the flexing zone.

14. The device of claim 12 wherein the common base and at least three arm elements consist of a single piece of molded polymeric material.

15. The device of claim 14 wherein the polymeric material comprises an elastomeric polymer.
